(19) United States
(12) Patent Application Publication
(10) Pub. No.: US 2007/0063934 A1
(43) Pub. Date: Mar. 22, 2007

(54) Drive apparatus and drive method for light emitting display panel

(75) Inventors: Mayumi Ozaki, Yonezawa-shi (JP); Katsuhiro Kanauchi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Yamagata (JP)

(21) Appl. No.: 11/520,762

(22) Filed: Sep. 14, 2006

(30) Foreign Application Priority Data
Sep. 21, 2005 (JP) 2005-274406

(51) Int. Cl. G09G 3/30

(52) U.S. Cl. 345/76

(57) ABSTRACT

One frame (period) is divided into a plurality of sub-frames including a lighting period and a non-lighting period for a pixel, and gradation control is carried out by selecting the above-mentioned sub-frames and by summing the lighting periods of the pixel within one frame period. In addition, proportions of the above-mentioned lighting period and the non-lighting period for every sub-frame are changed so as to perform selection operation of a gamma value of a gradation characteristic. A sum of the lighting periods within one frame period of the pixel at the time of setting the maximum gradation by way of the above-mentioned gradation control is set to be the same at the time of selecting any gamma value selected by the above-mentioned gamma value selection operation. Thus, it is possible to control luminosity changes generated when switching gamma values of gradation characteristics, especially at the time of the maximum gradation, and reduce degrees of a user's sense of incongruity.

### BACKGROUND OF THE INVENTION

Field of the Invention

The present invention relates to a drive apparatus for a light emitting display panel in which pixels that can emit light are arranged, for example, in a matrix pattern, and particularly relates to a drive apparatus and a drive method for a light emitting display panel, which can prevent a sense of incongruity from arising due to a large change in light-emission luminosity of the panel at the time of the maximum gradation when changing a gamma value of a gradation characteristic.

A display panel in which light emitting pixels are arranged in a matrix pattern has been widely developed.

As an example of such a display panel, a display in which a pixel is constituted by an organic EL (electroluminescence) element using an organic material for its luminescence layer has already been commercialized. This is also because there is a background where an organic compound which can be expected to provide a good luminescence characteristic is used for the luminescence layer of the EL element to allow a high efficiency and a long life, leading to practical use.

As a display panel using such an organic EL element, there have been proposed a passive matrix type display panel in which EL elements are merely arranged in a matrix pattern and an active matrix type display panel in which each of EL elements arranged in a matrix pattern is provided with a TFT (Thin Film Transistor), for example. Compared with the former passive matrix type display panel, the latter active-matrix type display panel can reduce power consumption and has an advantage in that there is less cross talk among pixels, thus being particularly suitable for a high definition display which constitutes a large screen.

FIG. 1 shows an example of a circuit structure corresponding to one pixel in the already proposed active-matrix type display panel. In addition, the structure of the pixel 1 as shown in this FIG. 1 shows an example in which a lighting drive system referred to as SES (Simultaneous Erasing Scan) that can realize time sharing gradation expression is employed. In the structure of this pixel 1, it is arranged that a data signal Vdata corresponding to an image signal from a data driver may be supplied to a source of a TFT for control, i.e., a data write-in transistor Tr1, through a data line 2 arranged in the display panel.

It is arranged that a scanning signal Select (also referred to as a write-in pulse) may be supplied to a gate of the above-mentioned data write-in transistor Tr1 through a scanning line 3 connected to a scanning driver. A drain of the above-mentioned data write-in transistor Tr1 is connected to a gate of a lighting and driving TFT i.e., a lighting and driving transistor Tr2 and also connected to one terminal of a capacitor C1 for holding electric charges.

Further, a source of the lighting and driving transistor Tr2 is arranged to be connected with the other terminal of the above-mentioned capacitor C1 and supplied with a drive voltage Vcc via a power supply line 4. A drain of the above-mentioned lighting and driving transistor Tr2 is connected to an anode terminal of an organic EL element E1 as a light emitting element, and a cathode terminal of this organic EL element E1 is connected to a reference potential point (ground).

Furthermore, it is arranged that an erase signal Erase (also referred to as an erase pulse) may be supplied from an erase driver through an erase signal line 5 to a gate of an erase transistor Tr3 as a TFT for erase. A source and a drain of the erase transistor Tr3 are respectively connected to terminals of the above-mentioned capacitor C1.

In addition, in the circuit structure of the pixel 1 as shown in FIG. 1, only the drive transistor Tr2 is constituted by a p-channel type TFT, and others are constituted by n-channel type TFT's. A large number of pixels 1 having the above-mentioned structure are arranged in a matrix pattern, in a row direction and a column direction, to constitute a display panel.

In the structure of the pixel 1 as shown in FIG. 1, the write-in pulse Select as the scanning signal is supplied to the gate of the control transistor Tr1 from the scanning driver during an address period. Thus, a current corresponding to the data signal Vdata supplied from the data driver flows into the capacitor C1 through the source and the drain of the control transistor Tr1 to charge the capacitor C1.

Then, its charge voltage is supplied to the gate of the drive transistor Tr2, the transistor Tr2 passes the current corresponding to the gate voltage and the drive voltage Vcc supplied to the drain, to the above-mentioned EL element E1, so that the EL element E1 emits light.

When application of the above-mentioned write-in pulse to the gate of the above-mentioned control transistor Tr1 is stopped, the transistor Tr1 is so-called cut-off. However, the gate voltage of the drive transistor Tr2 is held by the electric charge accumulated in the capacitor C1, so that the drive current to the EL element E1 is maintained. Therefore, the EL element E1 can continue a lighting state corresponding to the above-mentioned data signal Vdata during the period until the next address operation (i.e., one frame period).

On the other hand, in the middle of a lighting period of the above-mentioned EL element E1 (for example, in the middle of one frame period), the erase pulse Erase which causes the erase transistor Tr3 to turn on is supplied from the above-mentioned erase driver. Thus, the electric charge charged in the capacitor C1 can be instantaneously eliminated (discharged). As a result, the drive transistor Tr2 is in a cut-off state, and the EL element E1 is turned off immediately.

In other words, the lighting period of the EL element E1 is controlled by controlling an output timing of the erase pulse Erase from the erase driver, so that multi-gradation expression can be realized. For example, patent document 1 as indicated below discloses a drive apparatus for the display panel in which the multi-gradation expression is realized by using a pixel structure provided with the above-mentioned erase transistor Tr3.

[Patent Document 1] Japanese Patent Publication (KOKAI) 2001-42822

Incidentally, as an example in which the multi-gradation expression is realized by means of the circuit structure as shown in the above-mentioned patent document 1, there has been proposed a drive method for a display panel in which one frame (period) is divided into a plurality of sub-frames, to control lighting of a pixel on a sub-frame by sub-frame basis. FIG. 2(a) shows an example of this, in which one frame (period) is divided into 15 sub-frames, for example, and the number of lightings on a sub-frame by sub-frame basis is controlled in one frame period, so as to realize 16 gradation expressions (100% non-lighting can also be considered as one gradation to provide 15+1 gradation expressions).

Now, in order to set the number of gradations, for example, as “10”, the EL element is lit and controlled in 1-10 sub-frames in one frame (period) as shown in FIG. 2(a), and the erase transistor Tr3 as shown in FIG. 1 is controlled and turned on after the 11th sub-frame to turn off the EL element in the remaining frame period. The above-mentioned gradation control is called a non-weighted sub-frame method, showing the case where gamma (γ)=1 as shown in FIG. 3 and a relationship between the gradation and the light-emission luminosity is substantially linear.

However, it is said that a luminosity characteristic with respect to the gradation is ideally around γ=1.8 to 2.5 in the case of lighting and displaying, for example, inside a room etc. where the circumference is not bright. In other words, as shown in FIG. 3, it is required that a luminosity difference between gradations is smaller on a lower gradation side, and the luminosity difference is larger on a higher gradation side. In addition, in FIG. 3, a luminosity value of “0” is chosen as a gradation “O”, and examples (γ=1.8, γ=2.2, γ=2.5) of γ-characteristics where the number of gradations is 16 are shown, respectively.

Then, in the pixel structure as shown in FIG. 1, when realizing a gradation expression of, for example, γ=2.5, it is required that each sub-frame period is further divided into a lighting period and a non-lighting period, as illustrated in FIG. 2(b), to light and drive of each EL element. In other words, lighting and driving control is required so that a proportion of the lighting period of the EL element in each sub-frame period is smaller on the lower gradation side (such as, on the side of numbers 1, 2, 3 . . . in FIG. 2) and the proportion of the lighting period of the EL element in each sub-frame period is larger on the higher gradation side (such as, on the side of numbers 13, 14, 15 . . . in FIG. 2).

Incidentally, as described above, when trying to control and change to the gamma value of each value by means of a lighting control means having the pixel structure as shown in FIG. 1, the luminosity value changes variously according to each γ value especially in the case where the gradation is set as the maximum. In other words, it is said that the luminosity of the pixel in human vision is substantially proportional to instantaneous luminosity of the pixel and an integration value of a lighting accumulation period. Therefore, as is evident from comparison between FIGS. 2(a) and (b), a considerable difference occurs between the lighting accumulation period of the pixel as shown in FIG. 2(a) where γ=1.0 and the lighting accumulation period of the pixel as shown in FIG. 2(b) where γ=2.5.

As a result, the luminosity of each pixel especially in the case where the gradation is set as the maximum is different according to the γ value. For example, when it is arranged that the above-mentioned γ value varies according to surrounding brightness, the luminosity of the pixel varies according to the change of the γ value, resulting in giving sense of incongruity to a user. This is because the lighting period of the pixel in each sub-frame is distributed so that light emission duty of the pixel may be the maximum for every γ value, when the γ value of the gradation characteristic is set up for each.

### SUMMARY OF THE INVENTION

The present invention is made in view of the above-mentioned problem, and provides a drive apparatus and a drive method for a light-emitting display panel which can control luminosity changes generated when switching γ values of gradation characteristics, especially at the time of the maximum gradation, and can reduce degrees of a user's sense of incongruity.

The drive apparatus in accordance with the present invention made in order to solve the above-mentioned problem is a drive apparatus for a light-emitting display panel in which pixels are arranged in intersections where a plurality of data lines intersect with a plurality of scanning lines and each of the above-mentioned pixels is selectively lit and driven, to display an image; the drive apparatus comprises a gradation control means for dividing one frame (period) into a plurality of sub-frames including a lighting period and a non-lighting period for the above-mentioned pixel, to realize gradation control by selecting the above-mentioned sub-frame (period)s and by summing the lighting periods of the pixel within one frame period, and a gamma value selection means for changing proportions of the above-mentioned lighting period and the non-lighting period for every sub-frame, so as to change a gamma value of a gradation characteristic; and a sum of the lighting periods within one frame period of the above-mentioned pixel at the time of setting the maximum gradation by the above-mentioned gradation control means is arranged to be the same at the time of selecting any gamma value selected by the above-mentioned gamma value selection means.

Further, the drive method in accordance with the present invention made in order to solve the above-mentioned problem is a drive method for a light emitting display panel in which pixels are arranged in intersections where a plurality of data lines intersect with a plurality of scanning lines and each of the above-mentioned pixels is selectively lit and driven, to display an image, wherein one frame (period) is divided into a plurality of sub-frames including a lighting period and a non-lighting period for the above-mentioned pixel, gradation control is realized by selecting the above-mentioned sub-frames and by summing the lighting periods of the pixel within one frame period, proportions of the above-mentioned lighting period and the non-lighting period for every sub-frame are changed so as to perform selection operation of a gamma value of a gradation characteristic, and a sum of the lighting periods within one frame period of the above-mentioned pixel at the time of setting the maximum gradation by way of the above-mentioned gradation control is arranged to be the same at the time of selecting any gamma value selected by the above-mentioned gamma value selection operation.

### BRIEF DESCRIPTION OF THE DRAWINGS

FIG. 1 is a wiring diagram showing an example of a circuit structure corresponding to one pixel in a conventional active-matrix type display panel;

FIG. 2 is a timing chart showing a lighting pattern of the pixel for every sub-frame in the case of realizing a conventional multi-gradation expression;

FIG. 3 is a graph showing relationships between luminosities and gradations, choosing the gamma value as a parameter;

FIG. 4 is a block diagram showing a first preferred embodiment in a drive apparatus for the display panel in accordance with the present invention;

FIG. 5 is a block diagram for explaining a basic function of a gamma value selection means used in a structure as shown in FIG. 4;

FIG. 6 is a timing chart showing a lighting pattern of the pixel for every sub-frame, carried out in the structure as shown in FIG. 4;

FIG. 7 is a graph showing relationships between luminosities and gradations, where the gamma value obtained by means of the structure as shown in FIG. 4 is chosen as a parameter;

FIG. 8 is a timing chart showing an example of timings of generating write-in pulses and erase pulses at the time of selecting one gamma characteristic;

FIG. 9 is a timing chart showing another example of timings of generating the write-in pulses and erase pulses at the time of selecting one gamma characteristic;

FIG. 10 is a block diagram showing a second preferred embodiment in the drive apparatus for the display panel in accordance with the present invention; and

FIG. 11 is a graph showing relationships between luminosities and gradations for every luminescence color employed in a structure as shown in FIG. 10.

### DESCRIPTION OF THE PREFERRED EMBODIMENTS

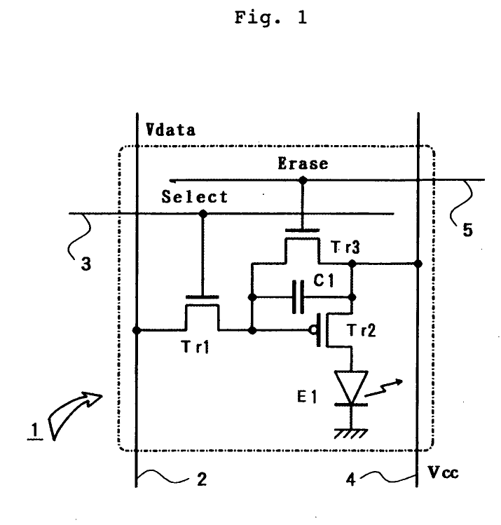

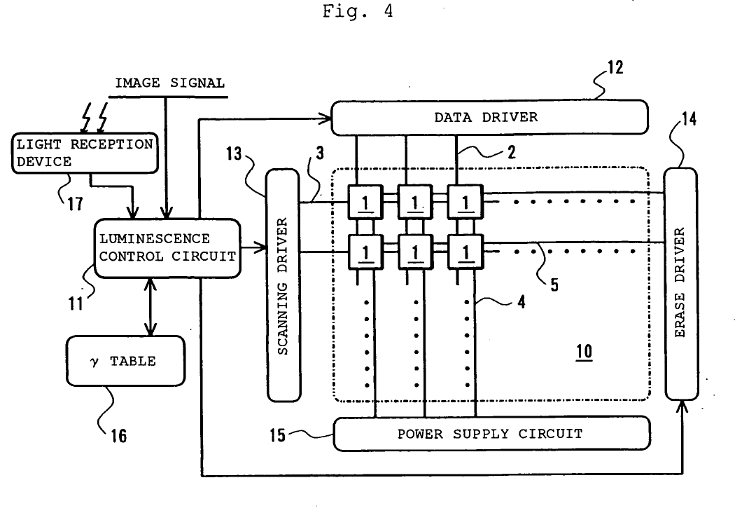

Hereafter, a drive apparatus for a light emitting display panel in accordance with the present invention will be described with reference to preferred embodiments shown in the drawings. FIG. 4 is a block diagram showing a structure of the drive apparatus. Pixels 1 having a structure as described with reference to FIG. 1 are arranged in a matrix pattern at a light emitting display panel as indicated by reference numeral 10. In other words, the pixels 1 are respectively formed in intersecting positions where respective data lines 2, respective scanning lines 3, power supply lines 4, and erase signal lines 5 intersect.

An image signal displayed at the above-mentioned light emitting display panel 10 is supplied to a luminescence control circuit 11. This luminescence control circuit 11 operates so that the inputted image signal is subjected to a sampling process etc. and converted into pixel data corresponding to each pixel, based on a horizontal synchronization signal and a vertical synchronization signal in the image signal, and that the data for each scan may be supplied to a data driver 12. It is arranged that data voltages Vdata corresponding to the above-mentioned pixel data are separately supplied to sources of the data write-in transistors Tr1 which constitute the respective pixels 1 by way of the above-mentioned operation. And the above-mentioned operation is repeated for every scan in the address period.

Further, a scanning clock signal corresponding to the horizontal synchronization signal is supplied from the above-mentioned luminescence control circuit 11 to a scanning driver 13 in the address period. Thus, the above-mentioned write-in pulses Select are arranged to be supplied one by one for every scanning line to the gates of the data write-in transistors Tr1 which constitute respective pixels 1.

Furthermore, a command signal corresponding to the gradation control is transmitted from the above-mentioned luminescence control circuit 11 to an erase driver 14, and the erase driver 14 acts so as to supply the erase pulse Erase which turns on the erase transistor Tr3 in the middle of the lighting period of the pixel 1 (in the middle of one sub-frame period).

Thus, as already described, the electric charge charged in the capacitor C1 as shown in FIG. 1 is instantaneously eliminated (discharged), and the EL element E1 is turned off immediately in the middle of the sub-frame period. In other words, the lighting period of the pixel in the sub-frame period is controlled by controlling the output timing of the erase pulse Erase from the erase driver 14.

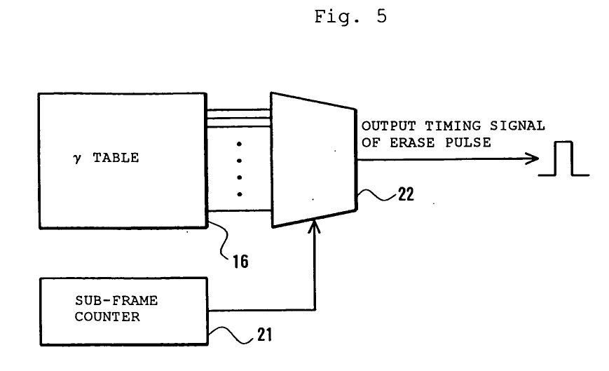

Further, it is arranged that each of the above-mentioned pixels 1 as shown in FIG. 4 is supplied with the drive voltage Vcc from the power supply circuit 15 through the power supply line 4. In addition, in the preferred embodiment as shown in FIG. 4, a γ table 16 which constitutes a gamma value selection means is connected to the luminescence control circuit 11. A function of this γ table 16 will be described later with reference to FIG. 5.

Furthermore, in the preferred embodiment as shown in FIG. 4, it is arranged that light reception output from a light reception device 17 which detects brightness around a display panel 10 is supplied to the luminescence control circuit 11, whereby selection operation of the γ value by the γ value selection means is arranged to be carried out. In this case, preferably it operates so that the greater γ value may be chosen with decreasing brightness around the display panel 10.

FIG. 5 shows a basic structure of the γ value selection means, and this shows the structure in which the output timing of the erase pulse Erase for turning on the above-mentioned erase transistor Tr3 can be controlled by selecting the γ value. In FIG. 5, reference numeral 21, reference numeral 22, and reference numeral 16 respectively indicate a sub-frame counter, a logical operation unit, and the γ table as described with reference to FIG. 4. In other words, as shown in FIG. 4 it is arranged that the above-mentioned γ table 16 is external to the luminescence control circuit 11 and a sub-frame counter 21 and the logical operation unit 22 are built in the luminescence control circuit 11.

Corresponding to the selected γ value, (information about) the lighting period for every sub-frame is stored in the above-mentioned γ table 16 as a parameter. When the sub-frame number to be lit and controlled is supplied from the sub-frame counter 21 to the logical operation unit 22, the logical operation unit 22 accesses the γ table 16 and operates so that the output timing signal of the above-mentioned erase pulse may be generated based on the parameter of the lighting time stored corresponding to the sub-frame number.

This is generated as the output timing signal of the erase pulse for each sub-frame number corresponding to a respective one of the γ values selected as described above. This timing signal is supplied to the above-mentioned erase driver 14 and operates so that, based on the above-mentioned timing signal, the erase pulse may be outputted from the erase driver 14 for each sub-frame as will be described in detail later.

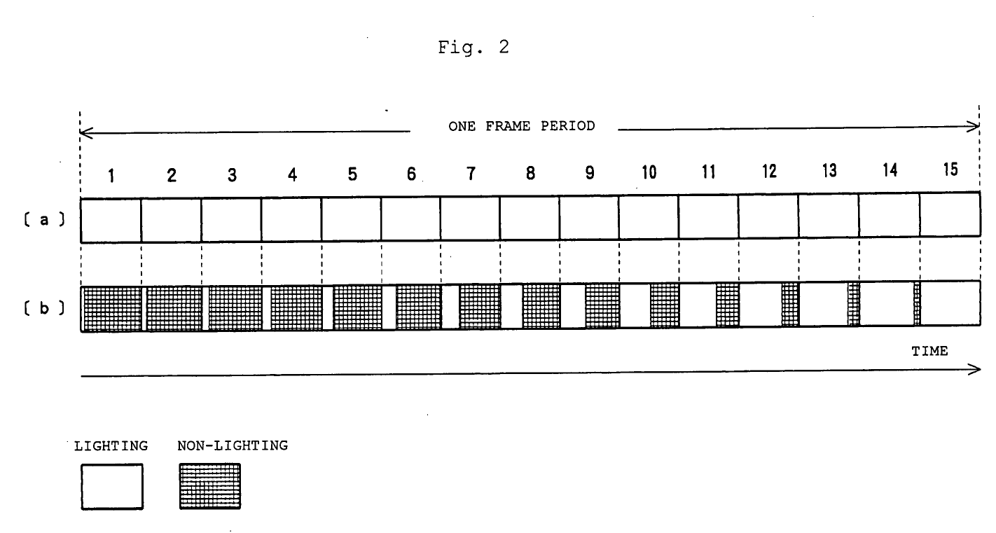

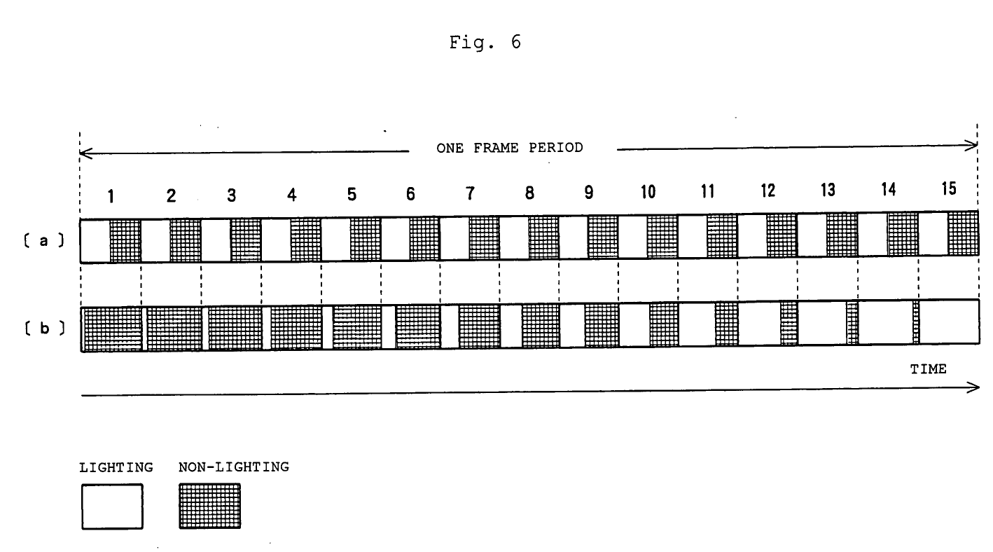

FIG. 6 illustrates the lighting period of the EL element for every sub-frame selected by the above-mentioned γ value selection means. In addition, the example as shown in this FIG. 6 illustrates an example in which one frame (period) is divided into 15 sub-frames similar to FIG. 2 as already described to realize gradation control of 16 steps. Thus, one frame (period) is divided into a plurality of sub-frames including a lighting period and a non-lighting period for a pixel, and the above-mentioned sub-frames are selected to sum the lighting periods of the pixel within one frame period and to thereby construct a gradation control means for realizing the gradation control.

FIG. 6(a) illustrates a relationship (proportion) between the lighting period and the non-lighting period for every sub-frame when the γ value is set to “1.0”, and FIG. 6(b) illustrates a relationship (proportion) between the lighting period and the non-lighting period for every sub-frame when the γ value is set to “2.5”,

As shown in FIG. 6(a) and FIG. 6 (b), the sums of the lighting periods within one frame period of the pixel at the time of setting the maximum gradation by the above-mentioned gradation control means are set up so as to be the same.

In other words, the sums of the lighting periods provided in one frame period as shown in FIG. 6(a) and FIG. 6(b) are set up so as to be the same as each other.

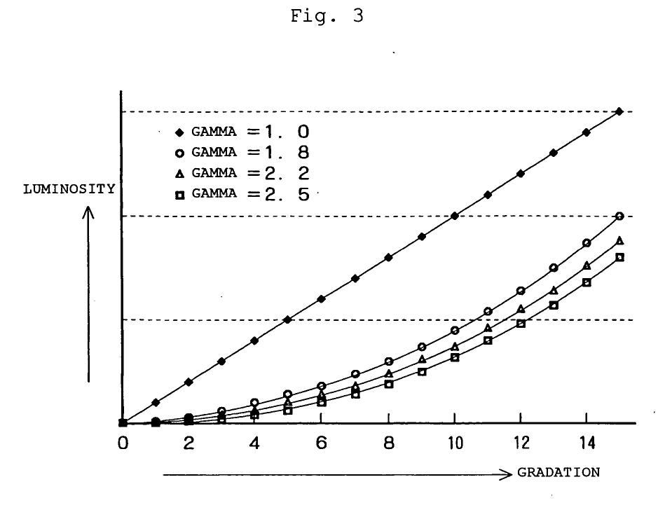

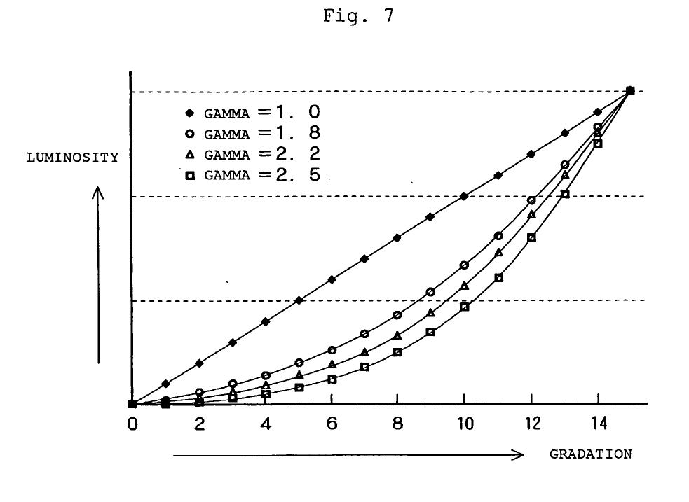

FIG. 7 shows a luminosity characteristic with respect to a gradation for each γ value, and shows examples where γ=1.0, γ=1.8, γ=2.2, and γ=2.5 similar to the example shown in FIG. 3 as already described. As is clear from each γ characteristic shown in this FIG. 7, the luminosities (sums of the lighting periods within one frame period) of the pixel are arranged to be the same in the gradation 15 that is the maximum gradation.

This is what the luminosity characteristic at each of γ=1.0, γ=1.8, and γ=2.2 is set up so as to be in agreement with the luminosity of the pixel when it is set up as the gradation 15 at γ=2.5 shown in FIG. 3 as already described. Therefore, a scale of a vertical axis as shown in FIG. 7 is different from a scale of a vertical axis as shown in FIG. 3, and the scale of the vertical axis as shown in FIG. 7 is illustrated in a situation where it is expanded to about twice the scale of the vertical axis as shown in FIG. 3.

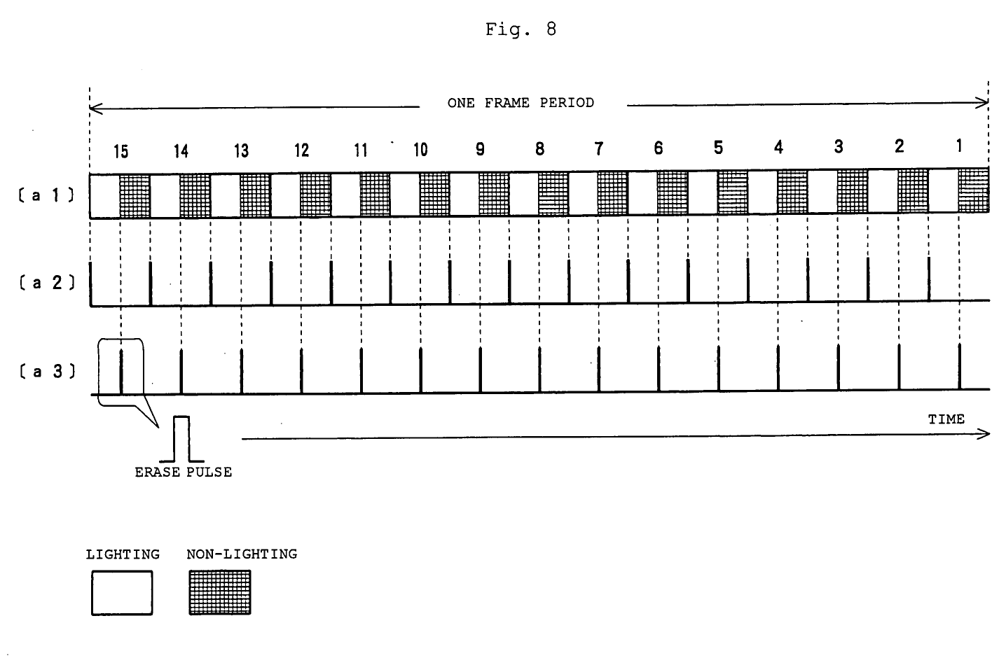

FIG. 8 explains lighting control of the pixel in each sub-frame at γ=1.0 as shown in FIG. 6(a). Here, FIG. 8(a1) shows a lighting pattern of the EL element for every sub-frame shown in FIG. 6(a) as already described. FIG. 8(a2) shows a generation timing of the write-in pulse Select for turning on the write-in transistor Tr1 in every sub-frame. Further, FIG. 8(a3) shows a generation timing of the erase pulse Erase for turning on the erase transistor Tr3 in every sub-frame.

In the example as shown in FIG. 8, the write-in pulse as shown in FIG. 8(a2) takes place in synchronization with the start of each sub-frame, whereby the pixel is changed into a lighting state. Then, in the middle of a lapse of time during the sub-frame period, the erase pulse as shown in FIG. 8(a3) takes place, whereby the pixel is changed into a non-lighting state.

The above-mentioned erase pulse is generated according to the structure shown in FIG. 5 as already described. In addition, the generation timing of the erase pulse as shown in FIG. 8 is controlled to be generated in the same timing in every sub-frame, whereby the relationship between the gradation and the luminescence luminosity is caused to be γ=1.0 which is substantially linear.

Further, when trying to realize the gradation “15” (for example), a series of lighting patterns as shown in FIG. 8(a1) are carried out for the pixel in one frame period. When trying to realize the gradation “10” (for example), lighting patterns similar to the above are carried out after the number 10 as shown in FIG. 8, whereby it is possible to obtain the luminosity according to the sum of the lighting periods of the pixel in one frame period.

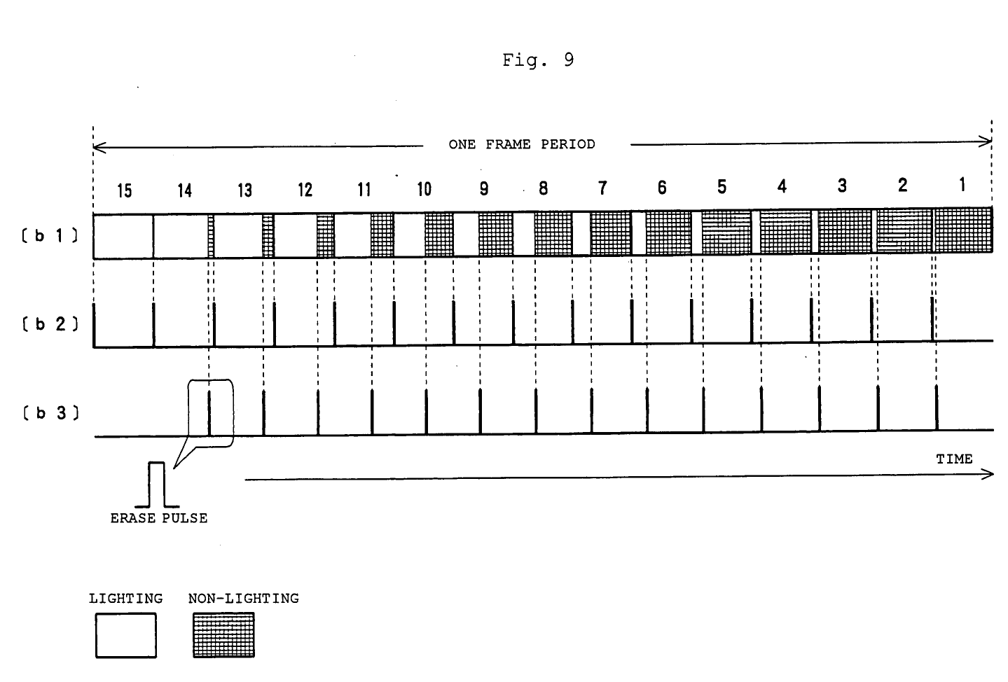

FIG. 9 explains the lighting control of the pixel in each sub-frame at γ=2.5 as shown in FIG. 6(b). Here, FIG. 9(b1) shows the lighting pattern of the pixel for every sub-frame shown in FIG. 6(b) as already described. FIG. 9(b2) shows a generation timing of the write-in pulse Select for turning on the write-in transistor Tr1 in every sub-frame. Furthermore, FIG. 9(b3) shows a generation timing of the erase pulse Erase for turning on the erase transistor Tr3 in every sub-frame.

In the example shown in FIG. 9, the write-in pulse as shown in FIG. 9(b2) takes place in synchronization with the start of each sub-frame, whereby the pixel is changed into the lighting state. Then, the erase pulse as shown in FIG. 9(a3) takes place in the middle of the lapse of time during the sub-frame period, whereby the pixel is changed into the non-lighting state. The above-mentioned erase pulse is generated according to the structure shown in FIG. 5 as already described. The generation timing of the erase pulse as shown in this FIG. 9 is controlled to be outputted in an early stage of the lapse of time during each sub-frame period as the number indicating each sub-frame decreases. Thus, the relationship between the gradation and the luminescence luminosity is caused to be γ=2.5 as shown in FIG. 7.

When trying to realize the gradation “15” (for example), a series of lighting patterns as shown in FIG. 9(b1) are performed for the pixel in one frame period. Further, when trying to realize the gradation “10” (for example), the lighting patterns are carried out after the number 10 as shown in FIG. 9, whereby it is possible to obtain the luminosity according to the sum of the lighting periods of the pixel in one frame period.

In addition, although FIGS. 8 and 9 each explain the luminescence control for each sub-frame at γ=1.0 and γ=2.5, the control modes (not shown) are the same also in the case of γ=1.8 and γ=2.2 as shown in FIG. 7, therefore the description will not be repeated.

According to the above-mentioned control modes, since the sum of the lighting periods within one frame period of the pixel at the time of setting the maximum gradation is particularly set up so as to be the same at the time of selecting any γ value selected by the γ value selection means, it is possible to solve the problem in that the luminosity of the screen changes considerably as the γ value is changed in a situation where an especially bright image is displayed.

Further, according to the above-mentioned control mode, since the luminescence luminosity value of the pixel at the time of the maximum gradation when the γ value is selected to be small (γ=1.0) can be controlled, it is also possible to reduce the power consumption and ease design criteria, such as current capacity of a power supply circuit, etc.

In addition, as already described, the above-mentioned expression that the sums of the lighting periods are set up so as to be the same at the time of selecting any γ value is carried out based on an idea that a luminescence duty of the pixel at γ=1.0 is brought into agreement with a luminescence duty of the pixel at γ=2.5, Thus, there is a technical feature that the luminosity of the display panel at the time of the maximum gradation changes with changes in the above-mentioned γ value, so that a user's sense of incongruity can be inhibited.

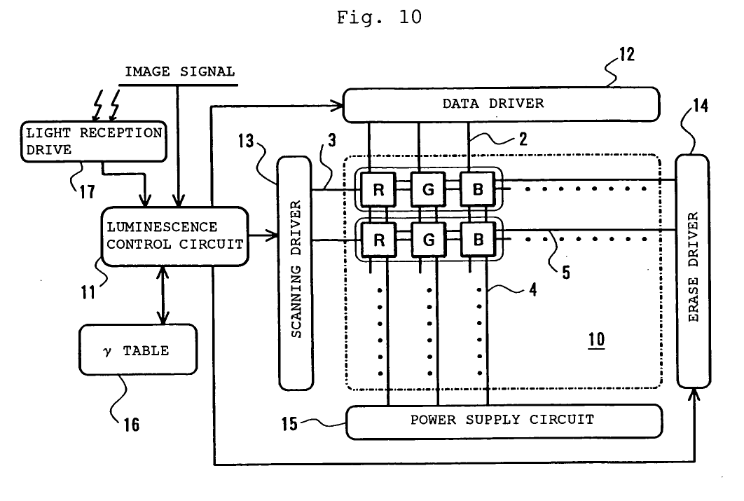

In the preferred embodiments as described above, it is assumed that the light emitting elements (EL elements) which constitute the respective pixels are luminescence drive devices of monochrome displays which emit lights in the same color. On the other hand, in the preferred embodiment as shown in FIG. 10, the display panel is illustrated in which the EL elements for providing luminescence colors of R (red), G (green), and B (blue) are respectively used to constitute sub-pixels and these three sub-pixels are combined into one group to constitute a unit pixel, thus allowing color display.

Also the drive apparatus for the color display panel 10 as shown in this FIG. 10 is substantially the same as the drive apparatus as shown in FIG. 4, and therefore like parts achieving the same functions are respectively given like reference numerals. And, it is arranged that the data signals Vdata from the data driver 12 may be individually supplied corresponding to each of the above-mentioned sub-pixels R, G, and B, respectively. In this case, since the luminosities (required for obtaining white) of the EL elements each constituting the above-mentioned R, G, and B differ, it is difficult to obtain a good color display (white balance).

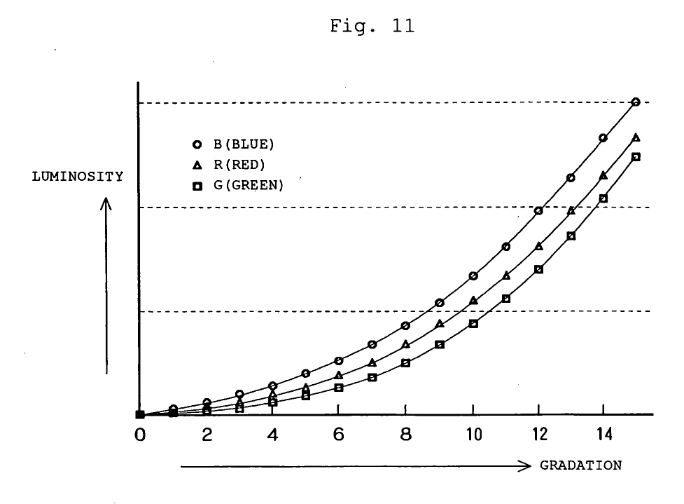

Then, it is desirable that the drive apparatus for the color display panel as described above is provided with the luminosity characteristic with respect to the gradation as shown in FIG. 11 for each of the above-mentioned R, G, and B. In other words, as shown in FIG. 11, it is arranged that the sums of the lighting periods of each pixel within one frame period corresponding to each gradation are set up each corresponding to the above-mentioned respective R, and G and B, thus realizing the color display maintaining the good white balance.

In addition, although the preferred embodiments as described above illustrate the examples in which the gradation control is carried out with 16 steps, it is not limited thereto. When realizing 32 or 64 steps for the gradation control, the number of sub-frames in one frame period can be increased, and it is possible to employ a similar control mode. Further, in the preferred embodiments as described above, although the examples using the organic EL element as the light emitting element which constitutes each pixel are shown, it is possible to obtain similar operational effects even when it is employed for a drive apparatus of flat panels, such as a light emitting diode and plasma.

What is claimed is:

1. A drive apparatus for a light-emitting display panel in which pixels are arranged in intersections where a plurality of data lines intersect with a plurality of scanning lines and each of the above-mentioned pixels is selectively lit and driven, to display an image, said drive apparatus comprising:
a gradation control means for dividing one frame (period) into a plurality of sub-frames including a lighting period and a non-lighting period for said pixel, to realize gradation control by selecting said sub-frame (period)s and by summing the lighting periods of the pixel within one frame period; and
a gamma value selection means for changing proportions of said lighting period and the non-lighting period for every sub-frame, so as to change a gamma value of a gradation characteristic, wherein a sum of the lighting periods within one frame period of said pixel at the time of setting the maximum gradation by said gradation control means is set to be the same at the time of selecting any gamma value selected by said gamma value selection means.

2. The drive apparatus for the light-emitting display panel as claimed in claim 1, wherein said gamma value selection means is arranged to perform selection operation of said gamma value according to brightness around said display panel.

3. The drive apparatus for the light-emitting display panel as claimed in claim 1, in which each pixel arranged in said display panel is constituted by mutually different luminescence colors, and wherein the sum of the lighting periods corresponding to each gradation for each pixel within one frame period is set up for each of different luminescence colors.

4. The drive apparatus for the light-emitting display panel as claimed in claim 2, in which each pixel arranged in said display panel is constituted by mutually different luminescence colors, and wherein the sum of the lighting periods corresponding to each gradation for each pixel within one frame period is set up for each of different luminescence colors.

5. The drive apparatus for the light-emitting display panel as claimed in any one of claims 1 to 4, wherein an erase driver is provided which outputs an erase pulse to the pixel to turn off the pixel, and a proportion between said lighting period and non-lighting period for each sub-frame is changed by controlling an output timing of said erase pulse from said erase driver.

6. The drive apparatus for the light-emitting display panel as claimed in any one of claims 1 to 4, wherein each pixel arranged at said display panel is constituted by an organic EL element in which an organic compound is used for a luminescence layer.

7. The drive apparatus for the light-emitting display panel as claimed in claim 5, wherein each pixel arranged at said display panel is constituted by an organic EL element in which an organic compound is used for a luminescence layer.

8. A drive method for a light emitting display panel in which pixels are arranged in intersections where a plurality of data lines intersect with a plurality of scanning lines and each of said pixels is selectively lit and driven, to display an image, wherein
one frame (period) is divided into a plurality of sub-frames including a lighting period and a non-lighting period for said pixel,
gradation control is carried out by selecting said sub-frames and by summing the lighting periods of the pixel within one frame period,
proportions of said lighting period and the non-lighting period for every sub-frame are changed so as to perform selection operation of a gamma value of a gradation characteristic, and
a sum of the lighting periods within one frame period of said pixel at the time of setting the maximum gradation by way of said gradation control is set to be the same at the time of selecting any gamma value selected by said gamma value selection operation.

9. The drive method for the light emitting display panel as claimed in claim 8, wherein said gamma value selection operation is performed according to brightness around said display panel.

10. The drive method for the light-emitting display panel as claimed in claim 8, in which each pixel arranged in said display panel is constituted by mutually different luminescence colors, and wherein the sum of the lighting periods corresponding to each gradation for each pixel within one frame period is set up for each of different luminescence colors.

11. The drive method for the light-emitting display panel as claimed in claim 9, in which each pixel arranged in said display panel is constituted by mutually different luminescence colors, and wherein the sum of the lighting periods corresponding to each gradation for each pixel within one frame period is set up for each of different luminescence colors.

12. The drive method for the light-emitting display panel as claimed in any one of claims 8 to 11, wherein an erase pulse is outputted from an erase driver to the pixel to turn off the pixel, and a proportion between said lighting period and non-lighting period for each sub-frame is changed by controlling an output timing of said erase pulse from said erase driver.
